(19) United States
(12) Patent Application Publication
(10) Pub. No.: US 2012/0199167 A1
(43) Pub. Date: Aug. 9, 2012

(54) CLEAN-IN-PLACE DEVICE FOR A MILK CONVEYING SYSTEM

(75) Inventors: Epke Bosma, Holo (SE); Nils-Erik Holmertz, Huddinge (SE)

(73) Assignee: DELAVAL HOLDING AB, Tumba (SE)

(21) Appl. No.: 13/501,105

(22) PCT Filed: Oct. 12, 2010
(86) PCT No.: PCT/EP2010/065252

§ 371 Date: Apr. 10, 2012

(30) Foreign Application Priority Data
Oct. 14, 2009 (SE) 0950758-3

(51) Int. Cl. B08B 9/00; B08B 5/00; B08B 3/04

(52) U.S. Cl. 134/171

(57) ABSTRACT

A clean-in-place device for a milk conveying system. The milk conveying system includes at least two separate areas (A, B) with surfaces difficult to clean. The clean-in-place device includes a steam source (24), steam passages (25, 26) extending between the steam source (24) and a respective outlet opening (25a, 26a) from which it is possible to supply steam to these areas (A, B) of the milk conveying system and control unit (7, 27) adapted to control the supply of steam from the steam source (24) to these areas (A, B) of the milk conveying system.

### THE BACKGROUND OF THE INVENTION AND PRIOR ART

The present invention relates to a clean-in-place device for a milk conveying system, wherein the milk conveying system comprises at least a separate first area with a surface difficult to clean and a separate second area with a surface difficult to clean.

Milk conveying systems are, for example, used in parlours comprising one or several milking stalls. Teat cups are attached to animals in the milking stalls by means of a robot arm or an operator. In each milking stall, a milk conveying system is used conveying milk from teat cups, via milk conduits, to a milk receiver. The milk in the milk receiver is then pumped, via milk lines, to a main milk tank for a plurality of milking stalls.

Milk conveying systems have to be cleaned with regular intervals in order to prevent formation of milk deposits and bacteriological pollutions. It is known to use so called clean-in-place (CIP) devices for cleaning the inner surfaces of milk conveying system and other types of liquid conveying systems. A clean-in-place device cleans the inner surfaces of liquid conveying system without disassembling of pipes, vessels and other components in the liquid conveying system. A conventional clean-in-place device for a milk conveying system comprises a cleaning unit which supplies cleaning liquid with a desired composition and temperature to the milk conveying system. The clean-in-place device may comprise an inlet line supplying cleaning liquid to the teat cups and a return line recirculating cleaning liquid from an end part of the milk conveying system to the inlet line such that the cleaning liquid is circulated in a closed circuit during a cleaning process of the milk conveying system. The cleaning liquid may be circulated through the closed circuit during a predetermined period of time.

However, it is difficult to clean all surfaces of a milk conveying system efficiently by means of a circulated cleaning liquid. It is a risk that certain surfaces will not be cleaned in an acceptable manner. A milk conveying system comprises, for example, a lot of valves having surfaces which are difficult to clean by a circulating cleaning liquid. Furthermore, in low flow areas of the milk conveying system and in joining areas between different components of the milk conveying system there is a risk that bacteria and micro-organisms are formed on the milk conveying surfaces. Thus, certain surfaces in a milk conveying system need to be cleaned more thoroughly than the main part of the surfaces in the milk conveying system.

U.S. Pat. No. 2,616,809 shows a milk conveying system where water and steam are supplied to a milk tank and downstream located components of a milk conveying system in order to ordinary clean and then sterilize the inner surfaces of the milk conveying system. In this case, large amount of steam has to be used for sterilizing the whole inner surfaces of the milk tank and the downstream located components.

WO 03/077645 shows a cleaning device for cleaning teat cups. Initially, the teat cups a flushed with a cleaning liquid. Thereafter, the teat cups are disinfected by steam. Also in this case, steam is used to sterilize all surfaces of the teat cups after that they have been cleaned by a cleaning liquid.

### SUMMARY OF THE INVENTION

The object of the present invention is to provide a clean-in-place device which performs an effective cleaning of predetermined surfaces in a milk conveying system which surfaces are difficult to clean by ordinary cleaning devices.

This object is achieved by the clean-in-place device initially defined, which is characterised in that it comprises a steam source, a first steam passage extending between the steam source and an outlet opening from which it is possible to supply steam to the first area of the milk conveying system, a second steam passage extending between the steam source and an outlet opening from which it is possible to supply steam to the second area of the milk conveying system and control means adapted to control the supply of steam from the steam source to said areas of the milk conveying system. It is possible to store large amount of heat energy in steam. The supplied steam heats relatively quickly up the surfaces difficult to clean to a high temperature such that bacteria and micro-organisms on said surfaces are killed. Consequently, it is possible to perform a high quality cleaning process of surfaces difficult to clean by means of a steam supply. However, the generation of steam requires large amounts of electric energy. It is therefore of interest to keep the consumption of steam low. In this case, the consumption of steam is low since the steam is only supplied to restricted areas of the milk conveying system.

According to an embodiment of the invention, at least one of the outlet openings of the steam passages is arranged at a smaller distance than 10 cm from said surfaces. Preferably, the outlet opening of the steam passages are arranged as close as possible to the surfaces to be cleaned. In order to heat a surface to a desired temperature, it has to be heated by a certain amount of steam. The required amount of steam is related to the distance between the outlet opening and the surface to be cleaned. If the distance is long, a main part of the steam will hit other surfaces than the surfaces to be cleaned. Thus in order to restrict the consumption of steam, a close positioning of the outlet openings in relation to said surfaces to be cleaned is to prefer.

According to a preferred embodiment of the invention, the control means is adapted to supply steam in a manner such that at least a part of the steam condensates in said areas. The hot steam which comes in contact with surfaces in said areas heats the surfaces. At the same time, the steam is cooled down. When the steam has been cooled to a temperature of 100° C., it undergoes a phase transition and condensates to liquid water. During this phase transition large amounts of heat energy are released which are able to heat said surfaces to be cleaned to a temperature corresponding to the condensation temperature of the steam. This temperature is high enough to kill bacteria and micro-organisms on said surfaces.

According to a preferred embodiment of the invention, it comprises several outlet openings from which it is possible to supply steam to the first area or the second area of the milk conveying system. In this case, it is possible to supply steam from different directions to a surface to be heated by the steam. At least one of the outlet openings may be arranged in a position such that the supplied steam comes in direct contact with said surface difficult to clean of the first or second area. The most effective mariner to clean a surface with steam is to supply the steam such that it comes in direct contact with the surface to be cleaned. Alternatively, at least one of the outlet openings is arranged in a position such that the supplied steam comes in contact with a contact surface located at a small distance from said surface difficult to clean of the first or second area. In certain cases, it is difficult to arrange an outlet opening in a position such that it is able to supply steam to the surface to be cleaned. However, the milk conveying system is usually formed by components manufactured of materials, such as metals, having good heat transferring properties. If steam is supplied to a contact surface of such a component, the heat will easily be transferred from the contact surface to an adjacent surface difficult to clean of the component. Such a surface difficult to clean of the component will be heated to substantially the same high temperature as the contact surface. The high temperature kills bacteria and micro-organisms on the surface difficult to clean. The contact surface may be a surface located radially outside said surface difficult to clean in the first or second area. In this case, the steam is supplied to an outer surface of a component of the milk conveying system. The heat from the outer surface is transferred through the component. Since the wall thickness of such components many times is relatively thin, it is possible to heat the inner surface of the component in an effective manner by supplying hot steam on an outer surface of the component. The clean-in-place device may comprise a housing or the like forming a closed space around the component enclosing the supplied steam.

According to a preferred embodiment of the invention, the steam source comprises a steam accumulator containing steam at an overpressure. The control means may comprise a valve mechanism adapted to control the supply of steam to said areas of the milk conveying system. The steam source may be an insulated accumulator tank storing steam at a suitable temperature and pressure. It is possible to generate the steam during a relatively long period of time by means of a relatively simple electric heater with a low capacity. It is possible to store the generated steam in such an accumulator tank. The steam may be stored at a suitable overpressure in the accumulator tank. When the valve mechanism is open, the steam flows by means of the overpressure in the accumulator tank, via the steam passage, to said areas of the milk conveying system, where the steam heats the predetermined surfaces.

According to a preferred embodiment of the invention, the control means comprises a control unit adapted to control the valve mechanism. The control unit may be a computer or the like provided with suitable software for this purpose. Alternatively, the valve mechanism may be manually controlled by an operator. Said steam passages may be formed by conduits extending between the steam source and the outlet openings. The steam conduit may have a relatively simple design. Each conduit may be used to convey steam to a certain area of the milk conveying system. Each steam passage may comprise a one-way valve comprising the outlet opening. A one-way valve is able to supply steam to the milk conveying system at the same time as it prevents that milk penetrates into the steam passages during a milking process.

According to an embodiment of the invention, at least one of said surfaces difficult to clean is a surface difficult to reach by a circulating cleaning liquid of the ordinary clean-in-place device. During an ordinary cleaning process, circulating liquid comes in contact with and cleans most of the inner surfaces of a milk conducting system in an acceptable manner. Usually, a milk conveying system comprises certain surfaces which are difficult to clean by a circulating liquid. At least one of said surfaces may be a surface of a valve member in the milk conducting system. A milk conveying system comprises a lot of valves of different kinds. Valves could include surfaces which are difficult to reach and clean by the circulating cleaning liquid. At least one of said surfaces may be located in an area of the milk conducting system where the milk flows relatively slowly. In such areas of the milk conveying system, there is a risk that bacteria and micro-organisms are formed. It is not obvious that a circulating cleaning liquid during an ordinary cleaning process is capable of killing bacteria and micro-organisms on said surfaces.

According to an embodiment of the invention, the milk conveying system comprises several components connected to each other. A milk conveying system usually comprises several components connected to each other such that they together form a relatively long milk conveying passage. At least one of said surfaces difficult to clean may be located in a joining area between two components of the milk conducting system. It is possible that the joining area between two components may comprise a weld joint or the like. It is not unusual that such areas have an uneven surface which is difficult to clean by a circulating cleaning liquid. Said areas may be located in different components of the milk conducting system. The most components in a milk conveying system may have at least one surface difficult to clean by an ordinary cleaning device. Said components connected to each other may be teat cups, milk conduits and a milk receiver. In a milking stall, the milk from an animal is usually conveyed from the teat cups and their milk conduits to a milk receiver. The milk in the milk receiver may be conveyed to a main milk tank for a plurality of milking stalls via a milk line by means of a milk pump.

According to a preferred embodiment of the invention, the clean-in-place device is adapted to supply steam to said surfaces difficult to clean of the milk conveying system after an ordinary clean-in-place device has performed a cleaning process of the milk conveying system. The combination of an ordinary cleaning process with a circulating cleaning liquid followed by a cleaning process according to the present invention results in a very high quality cleaning process of the whole milk conveying system. Alternatively, it is possible to perform the present cleaning process before the ordinary cleaning process. It is also possible to use the clean-in-place device according to the invention separately and supply steam to said surfaces difficult to clean without any associated ordinary cleaning process.

### BRIEF DESCRIPTION OF THE DRAWING

The present invention is now to be explained more closely by means of preferred embodiments which are disclosed as examples and with reference to the attached drawings.

FIG. 1 shows a milk conveying system with a clean-in-place device according to an embodiment of the invention,

FIG. 2 shows a second embodiment of the clean-in-place device,

FIG. 3 shows a third embodiment of the clean-in-place device and

FIG. 4 shows a fourth embodiment of the clean-in-place device.

### BRIEF DESCRIPTION OF A PREFERRED EMBODIMENT OF THE INVENTION

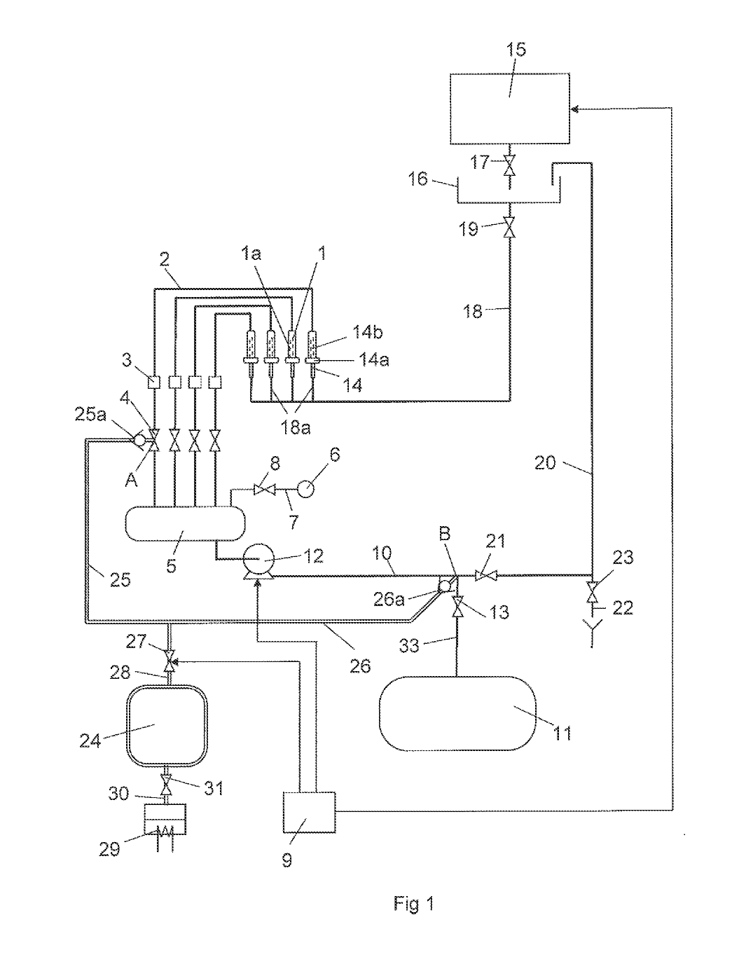

FIG. 1 shows a milk conveying system in a milking stall of a parlour. In this case, milk conveying system comprises four teat cups 1. However, the milk conveying system may comprise two teat cups or another number of teat cups. Each teat cup 1 comprises a recess 1a adapted to receive a teat during a milking process. The teat cups 1 are connected to a milk conduit 2. The milk conduits 2 are provided with a flow meter 3 and a valve 4. The milk conduits 2 are adapted to convey milk from the teat cups 1 to a milk receiver 5 in the milking stall. A vacuum source 6 is connectable to the milk receiver 5 by means of a vacuum line 7 and a control valve 8. A control unit 9 is adapted to control the control valves 8. Furthermore, the milk conveying system comprises a milk conduit 10 adapted to convey milk from the milk receiver 5 to a main milk tank 11 for a plurality of milking stalls of the parlour. A pump 12 is arranged in the milk conduit 10. A control valve 13 is adapted to control the milk flow through a conduit 33 to the main tank 11.

When a milking process has to be performed, a milking robot or an operator attaches the teat cups 1 to the teats of a milking animal in the milking stall. The control unit 9 opens the control valve 8 such that vacuum pressure is applied to the milk receiver 5 and the milk conduits 2. Thereby, milk is sucked from the teat cups 1, via the milk conduits 2, to the milk receiver 5. The control unit 9 closes the control valve 8 when the milking process has been finished and activates the pump 12 such that it pumps the milk from the milk receiver 5, via the milk conduit 10, to the main milk tank 11. The teat cups 1 are removed from the teats and are placed on a respective parking member 14 in the milking stall. The parking members 14 are adapted to hold the teat cups 1 in a parked position when they are not used. The teat cups are shown in the parked position in FIG. 1. The parking members 14 comprise a support portion 14a and a projecting rod-like portion 14b adapted to protrude into the recess 1a of the teat cups 1 when they are in a parked position. The teat cups 1 are provided with an opening to the recesses 1a which is directed downwards in the parked position.

The milk conveying system according to the above has to be cleaned at regular intervals. FIG. 1 shows a clean-in-place device (CIP) for cleaning of the milk conveying system. A clean-in-place device performs a cleaning process of the inner surfaces of the milk conveying system without dismounting of any including components of the milk conveying system. In this case, the clean-in-place device comprises an ordinary clean-in-place device and an additional clean-in-place device. The ordinary clean-in-place device comprises a cleaning unit 15 adapted to supply cleaning liquid of a desired composition and temperature to a cleaning trough 16 via a control valve 17. An inlet conduit 18 is adapted to receive cleaning liquid from the cleaning trough 15 via a control valve 19. The inlet conduit 18 comprises four branched portions 18a adapted to convey cleaning liquid to the respective parking members 14. The branched portions 18a of the inlet conduit 18 include one or several openings in the rod-like portions 14b of the parking members 14 from which the cleaning liquid is supplied to the recess 1a of the teat cups 1. The cleaning liquid is adapted to be supplied to the teat cups 1, by means of a vacuum pressure, such that it is sucked from the recess 1a of the teat cup 1 into the milk conduits 2 and to the milk receiver 5. Furthermore, the clean-in-place device comprises a return conduit 20 adapted to return cleaning liquid from the milk conduit 10 to the cleaning trough 16 during a cleaning process. A control valve 21 is adapted to control the flow of cleaning liquid from the milk conduit 10 to the return conduit 20. The return conduit 20 comprises a drain line 22 provided with a control valve 23.

FIG. 1 also shows an additional clean-in-place device. The additional clean-in-place device comprises, a steam accumulator 24, two steam conduits 25, 26 and a control valve 27 arranged in a common part of the steam conduits 25, 26. The steam accumulator 24 may be an insulated pressure tank containing steam at an overpressure. The steam conduit 25 comprises a one-way valve 25a at an end portion. The one-way 25a valve defines an outlet opening to an area A in a milk conduit 2 adjacent to the valve 4. Only one such one-way valve 25a is shown in FIG. 1 but the steam conduit 25 may be connected to all milk conduits 2 in the same manner. The steam conduit 26 has an end portion with an outlet opening in a joined area B between the milk line 10, the return conduit 20 and the conduit 33. The steam conduit 26 comprises a one-way vale 26a defining an outlet opening through which steam is supplied to the area B. The control unit 9 is adapted to control the supply of steam to said areas A, B by means of the control valve 27. A boiler 28 is adapted to heat liquid water such that it is evaporated to steam by means of an electric heating device 29. The steam is supplied to the container 24 via a steam line 30 and a control valve 31.

When a cleaning process of the milk conveying system has to be performed, the control unit 9 controls the cleaning unit 15 such that it supplies cleaning liquid with a desired temperature and composition to the cleaning trough 16. The cleaning liquid may be water or water with a detergent. The control unit 9 opens the control valve 19 such that cleaning liquid flows from the cleaning trough 16 to the inlet conduit 18 and to its branched portions 18a. The cleaning liquid flows from the branched portions 18a into the recesses 1a of teat cups 1 via the projecting members 14b of the parking members 14. The cleaning liquid flows then up in the milk conduits 2 and to the milk receiver 5. The control unit 9 starts the pump 12 such that it circulates cleaning liquid from the milk receiver 5 to the milk conduit 10. During the cleaning process, the control unit 9 has set the control valve 13 in a closed position and the control valve 21 in an open position such that the cleaning liquid flows from the milk conduit 10 to the return conduit 20. The return conduit 20 conveys the cleaning liquid back to the cleaning trough 16. Consequently, the cleaning liquid is circulated in a closed circuit during the cleaning process. When a desired quantity of cleaning liquid has been supplied to the flow circuit, the control unit 9 closes the control valve 17 such that no more cleaning liquid is supplied to the cleaning trough 16. The pump, which in this case is an existing milk pump 12 in the milk conveying system, circulates the cleaning liquid through the closed circuit. During the cleaning process, cleaning liquid is circulated in the closed circuit during a predetermined period of time. When the cleaning process of the milk conveying system is finished, the control unit 9 opens the control valves 23 such that the cleaning liquid is discharged from the circuit via the drain line 22.

Usually a milk conveying system comprises areas A, B with surfaces difficult to clean by means of the above mentioned ordinary clean-in-place device. The circulating cleaning liquid will, for example, not come in contact with all surfaces in the milk conveying system. The valves 4, 13, 21 of a milk conveying system may comprise such surfaces. The valves 4 in the areas A of the milk conduits 2 comprise in this embodiment such a surface. Furthermore, joining areas between different components of the milk conveying systems may comprise an uneven structure and be difficult to clean. The joining area B between the milk line 10 and the return conduit 20 comprises, in this embodiment, such a surface.

When the ordinary clean-in-place device has performed a cleaning process of the milk conveying system, the control unit 9 opens the control valve 27 such that steam is supplied from the steam accumulator 24 into the two steam conduits 25, 26. The steam in the steam conduit 25 is supplied by the respective one-way valves 25a to the area A and the surfaces difficult to clean of the valves 4. The outlet opening of the one-way valves 25a is arranged at a short distance from the surface difficult to clean such that the supplied steam will come in contact with the surface. The supplied steam may have a temperature above 100° C. The hot steam heats the surface. At the same time, the steam is cooled down. When the steam has been cooled down to a temperature of 100° C., it undergoes a phase transition and condensates to liquid water on the surface. During this phase transition large amounts of heat energy are released which are able to heat the surface to a temperature corresponding to the condensation temperature of the steam. This temperature is high enough to kill bacteria and micro-organisms on the surface A. At the same time steam is supplied to the area B by means of an outlet opening of the one-way valve 26a. The surface difficult to clean in the area B will also be heated to a temperature at which bacteria and micro-organisms will be killed. The ordinary clean-in-place process of the whole milk conveying system followed by such an additional clean-in-place process of predetermined surfaces in separate areas A, B of the milk conveying system result in a very high quality cleaning process of the milk conveying system. Finally, a post rinse process of the milk conveying system may be performed in order to flush out killed bacteria and microorganisms from the system.

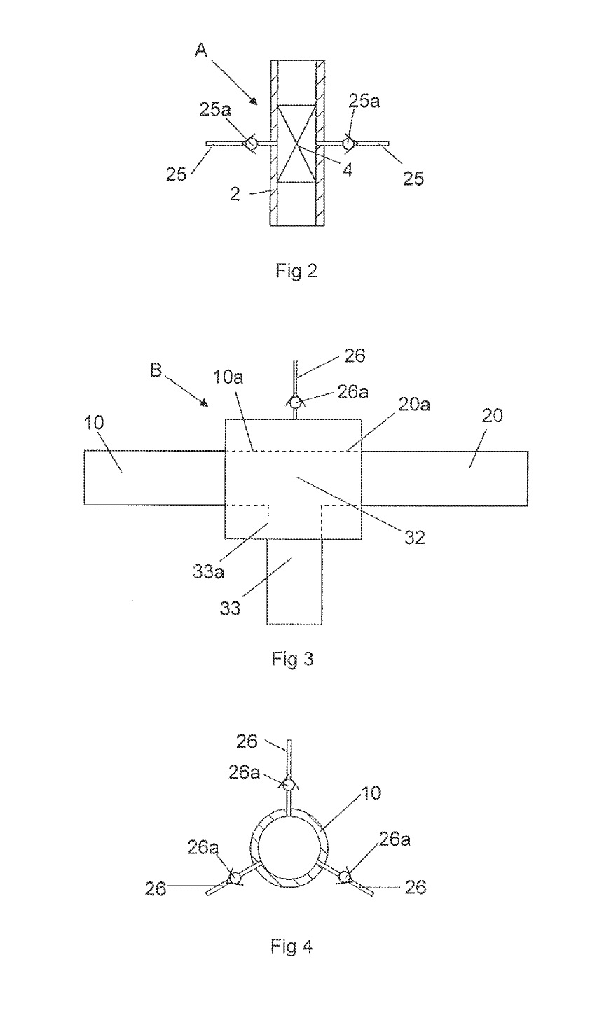

FIG. 2 shows the area A of the milk conveying system. In this case, two steam conduits 25 have been connected to the milk conduit 2 in the area A. Each steam conduit 25 comprises a one-way valve 25a adapted to supply steam to a surface difficult to clean of the valve 4. In this case, the steam is supplied to the valve 4 from two different directions. If, for example, the surface difficult to clean is relatively large or if it is has a curved shape, it may be favorable to supply the steam from different directions in order to supply steam uniformly to the whole surface difficult to clean.

FIG. 3 shows the area B of the milk conveying system. In this case, a housing 32 has been arranged on the outside of the joined area B between the milk conduit 10, the return conduit 20 and the conduit 33. The housing 32 forms a closed space around the outer surfaces 10a, 20a, 33a, of the conduits 10, 20, 33. A steam conduit 26 comprising a one-way valve 26a is adapted to supply steam to the inner space of the housing 32. The supplied steam heats the outer surfaces 10a, 20a, 33a of the conduits 10, 20, 33 in the area B. The conduits 10, 20, 33 are made of a relatively thin metal material having good heat transferring properties. Due to these facts, the inner surfaces of the conduits 10, 20, 33 in the area B will be heated to substantially the same high temperature as the outer surface 10a, 20a, 33a. This temperature is high enough to kill bacteria and micro-organisms on the inner surfaces of the conduits 10, 20, 33 difficult to clean.

FIG. 4 shows a cross section view of the milk conduit 10 in an area where the milk flows relatively slowly. In such areas of the milk conduit 10, there is a risk that bacteria and microorganisms are formed. It is not obvious that a circulating cleaning liquid during an ordinary cleaning process is capable of killing these bacteria and microorganisms. In this case, three steam conduits 26 have been connected to the milk conduit 10. The outlet openings of the steam conduits 26 are formed by one-way valves 26a adapted to supply steam to the inner surface of the milk conduit 10. The steam is here supplied to the inner space of the milk conduit 10 from three different positions located at the inner periphery of the milk conduit 10. Such a steam supply facilitates a uniform supply of steam to the whole inner surface of the milk conduit 10 and a correspondingly uniform heating of these surfaces.

The invention is not restricted to the described embodiment but may be varied freely within the scope of the claims. It is possible to supply steam to other areas and surfaces of the milk conveying system than in the above mentioned embodiment.

1-20. (canceled)

21. A clean-in-place device for a milk conveying system comprising a separate first area (A) with an interior surface to clean and a separate second area (B) with an interior surface to clean, the clean-in place device comprising:
a steam source (24) having an outlet configured to provide steam;
a first steam conduit (25) having i) an inlet portion connected to the outlet of the steam source (24), and ii) an outlet portion for supplying a first portion of the steam;
a second steam conduit (26) having i) an inlet portion connected to the outlet of the steam source (24), and ii) an outlet portion for supplying a second portion of the steam, first and second conduits (25, 26) arranged to split the steam so that the first and second steam potions are separate, mutually exclusive steam portions;
a first one-way valve (25a) at the end portion of the first steam conduit (25), the first one-way valve (25a) defining an outlet opening for supplying the first portion of the steam to the first area A of the milk conveying system, the first area A being an interior surface of a first portion of a milk conduit (2) of the milking system;
a second one-way valve (26a) at the end portion of the second steam conduit (26), the second one-way valve (26a) defining an outlet opening for supplying the second portion of the steam to the second area B of the milk conveying system, the second area B being an interior surface of a second portion of the milk conduit (2) in an area of the milking system downstream of the first area A; and
a control unit (9) configured to
i) control, by controlling the first one-way valve (25a), a supply of the first portion of the steam to the first area A including to the interior surface of the first portion of the milk conduit (2), and
ii) control, by controlling the second one-way valve (26a), a supply of the second portion of the steam to the second area B.

22. A clean-in-place device of claim 21, wherein,
an interior of a milk conduit valve (4) defines the interior surface of the first portion of the milk conduit (2) in the first area A, the milk conduit valve (4) controlling fluid flow through the milk conduit (2), the milk conduit valve (4) located upstream of a milk receiver (5) arranged to receive milk from the teat cups (1), and
an interior of a joined area defines the interior surface in second milk area B, the interior of a joined area being downstream of the milk receiver (5) and upstream of a main milk tank (11).

23. A clean-in-place device of claim 22, wherein,
an outlet opening of the first one-way valve (25a) is located at a distance less than 10 cm from the interior of the milk conduit valve (4), and
an outlet opening of the second one-way valve (26a) is located at a distance less than 10 cm from the interior of the joined area of second milk area B.

24. A clean-in-place device of claim 22, wherein,
an outlet opening of the first one-way valve (25a) is located at a distance from the interior of the milk conduit valve (4) such that at least a part of the first portion of the steam condensates in the interior of the milk conduit valve (4), and
an outlet opening of the second one-way valve (26a) is located at a distance from the interior of the joined area of second milk area B such that at least a part of the second portion of the steam condensates in the interior of the joined area of second milk area B.

25. A clean-in-place device of claim 22, wherein,
an outlet opening of the first one-way valve (25a) is located at a distance from the interior of the milk conduit valve (4) such that the steam supplied to the interior of the milk conduit valve (4) is at a temperature above 100° C., and
an outlet opening of the second one-way valve (26a) is located at a distance from the interior of the joined area of second milk area B such that the steam supplied to the interior of the joined area of second milk area B is at a temperature above 100° C.

26. A clean-in-place device of claim 22, wherein,
an outlet opening of the first one-way valve (25a) is arranged with respect to the interior of the milk conduit valve (4) such that the steam comes in direct contact with the interior of the milk conduit valve (4), and
an outlet opening of the second one-way valve (26a) is arranged with respect to the interior of the joined area of second milk area B such that the steam comes in direct contact with the interior of the joined area of second milk area B is at a temperature above 100° C.

27. A clean-in-place device of claim 22, further comprising:
another first one-way valve (25a) at the end portion of the first steam conduit (25), the another first one-way valve (25a) defining another outlet opening for supplying the first portion of the steam to the interior of the milk conduit valve (4) defining the interior surface of the first portion of the milk conduit (2),
wherein the first one-way valve (25a) and the another first one-way valve (25a) supply steam to the interior of the milk conduit valve (4) from two different directions.

28. A clean-in-place device of claim 21, wherein,
the second one-way valve (26a) further defines an outlet opening for supplying the second portion of steam to i) a second discharge portion of the milk conduit (10) remote from the first portion of the milk conduit (2) and the teat cups (1) of the milking system, ii) a return conduit (20) of a cleaning unit (15), and iii) a conduit (33) feeding a main milk tank (11) of the milking system.

29. A clean-in-place device of claim 21, wherein,
the second one-way valve (26a) further defines an outlet opening for supplying the second portion of steam to a joined area (B) of i) a second discharge portion of the milk conduit (10) remote from the first portion of the milk conduit (2) and the teat cups (1) of the milking system, ii) a return conduit (20) of a cleaning unit (15), and iii) a conduit (33) feeding a milk tank (11) of the milking system.

30. A clean-in-place device of claim 21, wherein,
the second one-way valve (26a) further defines an outlet opening for supplying the second portion of steam to an area between i) a second discharge portion of the milk conduit (10) remote from the first portion of the milk conduit (2) and the teat cups (1) of the milking system, and ii) a valve (13) receiving milk from the second discharge portion of the milk conduit (1) for feeding a conduit (33) feeding a milk tank (11) of the milking system.

31. A clean-in-place device of claim 21, further comprising:
a control valve (27) at an outlet of the steam source (24), wherein,
the inlets of the first and second steam conduits are connected to the outlet of the steam source (24) via the control valve (27),
the control unit (9) further configured to control a supply of the steam to the first and second steam conduits (25, 26) by controlling the control valve (27), and
the steam source comprises an steam accumulator (24) configured to contain the steam at the overpressure.

32. A clean-in-place device for a milk conveying system comprising a separate first area (A) with an interior surface to clean and a separate second area (B) with an interior surface to clean, the clean-in place device comprising:
a steam source (24) configured to provide steam;
a first steam conduit (25) having i) an inlet portion connected to the outlet of the steam source (24), and ii) an outlet portion for supplying a first portion of the steam;
a second steam conduit (26) having i) an inlet portion connected to the outlet of the steam source (24), and ii) an outlet portion for supplying a second portion of the steam, first and second conduits (25, 26) arranged to split the steam so that the first and second steam potions are separate, mutually exclusive steam portions;
a first outlet opening (25a) at the end portion of the first steam conduit (25), the outlet opening (25a) arranged for supplying the first portion of the steam to the first area A of the milk conveying system, the first area A being an interior surface of a first portion of a milk conduit (2);
a second outlet opening (26a) at the end portion of the second steam conduit (26), the second outlet opening (26a) arranged for supplying the second portion of the steam to the second area B of the milk conveying system; and
a control unit (9) configured to
i) control, via the first outlet opening (25a), a supply of the first portion of the steam to the first area A including to the interior surface of the first portion of the milk conduit (2), and
ii) control, via the second outlet opening (26a), a supply of the second portion of the steam to the second area B.

33. A clean-in-place device of claim 32, wherein,
the first outlet opening is defined by a first one-way valve (25a) at the end portion of the first steam conduit (25), and
the second outlet opening is defined by a second one-way valve (26a) at the end portion of the second steam conduit (26).

34. A clean-in-place device of claim 32, wherein,
an interior of a milk conduit valve (4) defines the interior surface of the first portion of the milk conduit (2) in the first area A, the milk conduit valve (4) controlling fluid flow through the milk conduit (2), the milk conduit valve (4) located upstream of a milk receiver (5) arranged to receive milk from the teat cups (1), and
an interior of a joined area defines the interior surface in second milk area B, the interior of a joined area being downstream of the milk receiver (5) and upstream of a main milk tank (11).

35. A clean-in-place device of claim 34, wherein,
the first outlet opening (25a) is located at a distance less than 10 cm from the interior of the milk conduit valve (4), and
the second outlet opening (26a) is located at a distance less than 10 cm from the interior of the joined area of second milk area B.

36. A clean-in-place device of claim 34, wherein,
the first outlet opening (25a) is located at a distance from the interior of the milk conduit valve (4) such that at least a part of the first portion of the steam condensates in the interior of the milk conduit valve (4), and
the second outlet opening (26a) is located at a distance from the interior of the joined area of second milk area B such that at least a part of the second portion of the steam condensates in the interior of the joined area of second milk area B.

37. A clean-in-place device of claim 34, wherein,
the first outlet opening (25a) is located at a distance from the interior of the milk conduit valve (4) such that the steam supplied to the interior of the milk conduit valve (4) is at a temperature above 100° C., and
the second outlet opening (26a) is located at a distance from the interior of the joined area of second milk area B such that the steam supplied to the interior of the joined area of second milk area B is at a temperature above 100° C.

38. A clean-in-place device of claim 34, wherein,
the first outlet opening (25a) is arranged with respect to the interior of the milk conduit valve (4) such that the steam comes in direct contact with the interior of the milk conduit valve (4), and
the second outlet opening (26a) is arranged with respect to the interior of the joined area of second milk area B such that the steam comes in direct contact with the interior of the joined area of second milk area B is at a temperature above 100° C.

39. A clean-in-place device of claim 34, further comprising:
another first outlet opening (25a) at the end portion of the first steam conduit (25), the another first outlet opening (25a) defining another outlet opening for supplying the first portion of the steam to the interior of the milk conduit valve (4) defining the interior surface of the first portion of the milk conduit (2),
wherein the first outlet opening (25a) and the another first outlet opening (25a) supply steam to the interior of the milk conduit valve (4) from two different directions.

40. A clean-in-place device of claim 33, wherein, the second one-way valve (26a) further defines an outlet opening for supplying the second portion of steam to i) a second discharge portion of the milk conduit (10) remote from the first portion of the milk conduit (2) and the teat cups (1) of the milking system, ii) a return conduit (20) of a cleaning unit (15), and iii) a conduit (33) feeding a main milk tank (11) of the milking system.
